(19) United States
(12) Patent Application Publication
(10) Pub. No.: US 2009/0277589 A1
(43) Pub. Date: Nov. 12, 2009

(54) Carpet Seaming Apparatus

(76) Inventor: Kevin Simpson, Lake Park, GA (US)

Correspondence Address: JAY M. SCHLOFF, 6960 Orchard Lake Road, Suite 315, West Bloomfield, MI, 48322, US

(21) Appl. No.: 12/117,356

(22) Filed: May 8, 2008

(51) Int. Cl. B65C 9/40

(52) U.S. Cl. 156/368

(57) ABSTRACT

Disclosed is a carpet seaming apparatus for coupling a pair of carpets with each other. The carpet seaming apparatus includes a base plate assembly, a holding member, and a power unit. The base plate assembly has a top surface and a bottom surface. The base plate assembly adapted to be heated upon receiving electric power. The holding member is mounted on the top surface of the base plate assembly. The holding member is configured to enable a user to hold the carpet seaming apparatus. The power unit is configured at the holding member and operatively coupled to the base plate assembly. The power unit is capable of supplying the electric power for heating the base plate assembly.

### FIELD OF THE INVENTION

The present invention relates generally to carpets, and more particularly to a carpet seaming apparatus to couple a plurality of carpets with each other.

### BACKGROUND OF THE INVENTION

Carpeting in homes and offices is widely used as a floor covering. Usually, to cover a floor having a large area, a plurality of carpets may be required. Accordingly, while laying the plurality of carpets on the floor, adjacent carpets may be coupled with one another so that the plurality of carpets appears as a single piece of carpet. Generally, a pair of carpets may be coupled to one another by placing the pair of carpets adjacent to each other such that edges thereof are adjoining to each other. Thereafter, a seaming tape may be utilized to join the adjoining edges of the pair of carpets. The seaming tapes have a glued surface and a non-glued surface. The glued surface of the seaming tapes may be used for joining adjoining edges of the pair of carpets. More specifically, glue present in the glued surface of a seaming tape may be melted to enable the seaming tape to adhere to the adjoining edges of the adjacent carpets forming a joint therebetween. Accordingly, the pair of carpets is coupled to each other.

Preferably, a carpet seaming apparatus may be utilized for melting the glue of the seaming tape. More particularly, the carpet seaming apparatus may be heated and moved on the glued surface of the seaming tape and thereafter the seaming tape may be adhered to the adjoining edges of the adjacent carpets. The melted glue of the seaming tape joins the adjoining edges of the adjacent carpets. Generally, a typical carpet seaming apparatus is connected by wires to a power source, thereby limiting a portability of the carpet seaming apparatus. The wires may need to be constantly dragged while using the carpet seaming apparatus. For instance, the wires may need to be adjusted when a user carrying the carpet seaming apparatus moves from one place to another for laying the carpets on the floor. Furthermore, the wires may get entangled frequently, thereby causing discomfort to the user. Moreover, the length of the wires may limit the usage of the carpet seaming apparatus. For example, for seaming carpets having long edges, the power source may be required to be shifted along the edges of the carpets to enable the carpet seaming apparatus to seam the entire length of the carpets. Accordingly, usage of a typical carpet seaming apparatus for coupling a plurality of carpets is tedious, time consuming and cumbersome for the user.

Further, in use, the carpet seaming apparatus may not uniformly distribute heat while moving on the seaming tape that may be adhered to the adjoining edges of the adjacent carpets, thereby causing damage to the carpets.

Accordingly, there is a need for a carpet seaming apparatus that can be easily carried by a user from one place to another, thereby providing the user with portability. Further, there is a need for a carpet seaming apparatus that is easy to use and that saves the user's time while installing the carpets on the floor. Moreover, there is a need for a carpet seaming apparatus that can uniformly distribute heat during operation thereby reducing the probability of carpet damage.

### SUMMARY OF THE INVENTION

In view of the foregoing disadvantages inherent in the prior art, the general purpose of the present invention is to provide a carpet seaming apparatus that is configured to include all advantages of the prior art, and to overcome the drawbacks inherent therein.

Accordingly, an object of the present invention is to provide a carpet seaming apparatus that may be easily carried by a user from one place to another for coupling a plurality of carpets.

Another object of the present invention is to provide a carpet seaming apparatus that may uniformly distribute heat while being utilized to couple a plurality of carpets.

In light of the above objects, in one aspect of the present invention, a carpet seaming apparatus is disclosed. The carpet seaming apparatus includes a base plate assembly, a holding member, and a power unit. The base plate assembly has a top surface and a bottom surface. The base plate assembly is adapted to be heated upon receiving electric power. The holding member is mounted on the top surface of the base plate assembly and is configured to enable a user to hold the carpet seaming apparatus therewith. Moreover, the power unit is configured at the holding member and is operatively coupled with the base plate assembly. More specifically, the power unit is capable of supplying the electric power for heating the base plate assembly.

In another aspect of the present invention, the bottom surface of the base plate assembly is configured with a plurality of grooves for enabling the carpet seaming apparatus to be utilized with a variety of seaming tapes for coupling a pair of carpets with each other.

In yet another aspect of the present invention, the bottom surface of the base plate assembly is coated with a non-stick coating material. The non-stick coating material precludes melted glue of the seaming tape from sticking on to the bottom surface of the base plate assembly.

These together with the other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a front view of a carpet seaming apparatus, in accordance with an exemplary embodiment of the present invention; and

FIG. 2 illustrates a bottom view of the carpet seaming apparatus of FIG. 1.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present invention provides a carpet seaming apparatus. The carpet seaming apparatus is adapted to couple a pair of carpets with each other. The carpet seaming apparatus is easy to use and is portable. Moreover, the carpet seaming apparatus may be utilized on a variety of carpets having different textures.

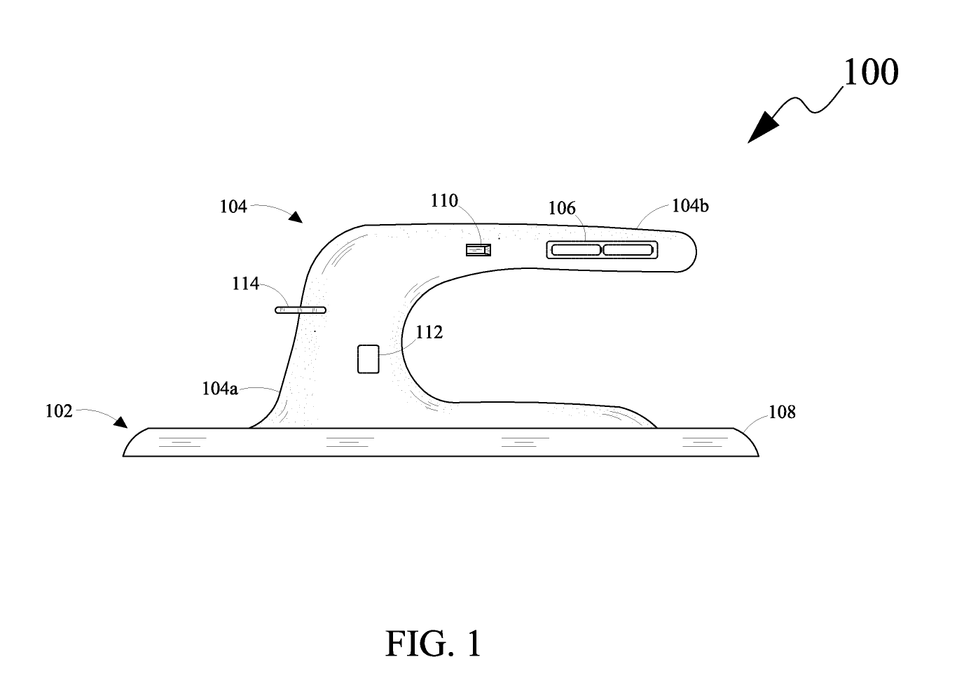

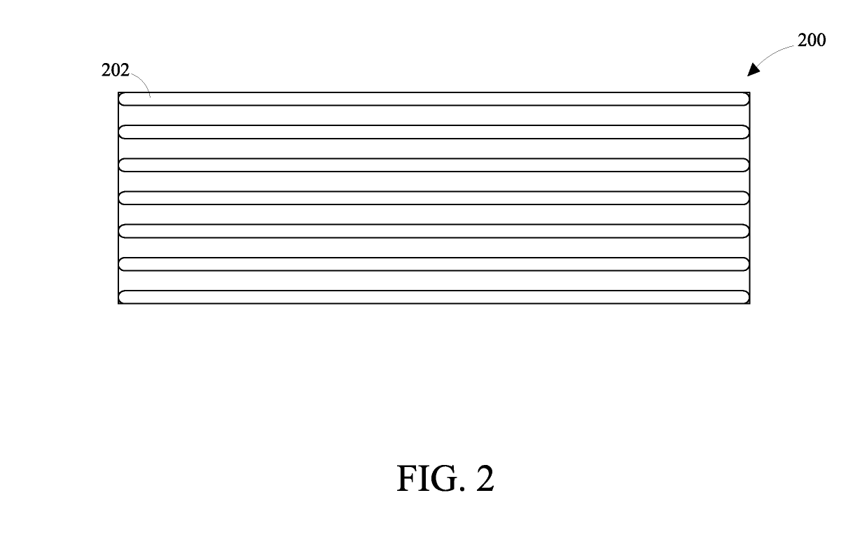

Referring to FIG. 1, a carpet seaming apparatus 100 is illustrated. More specifically, FIG. 1 illustrates a front view of the carpet seaming apparatus 100, in accordance with an embodiment of the present invention. The carpet seaming apparatus 100 may be utilized to couple a pair of carpets together. More specifically, the carpet seaming apparatus 100 may be moved on a seaming tape to heat the seaming tape. Subsequent to heating, the seaming tape may be adhered to adjoining edges of the pair of carpets for coupling the pair of carpets together. The carpet seaming apparatus 100 includes a base plate assembly 102, a holding member 104, and a power unit 106. Without limiting the scope of the present invention, the base plate assembly 102 may include a single base plate or a plurality of base plates that may be arranged in a layered form. In the layered form, each base plate of the plurality of base plates may be arranged in a stacked form. The base plate assembly 102 is composed of a high resistance metallic material, such that the base plate assembly 102 is adapted to be heated upon receiving electrical power. The base plate assembly 102 also may be composed of ceramic materials or stainless steel, and may optionally be at least partially coated with a silicone- or fluorocarbon-based non-stick material. The base plate assembly 102 may be heated to a temperature ranging from about 220° C. to about 420° C. Moreover, the base plate assembly 102 has a top surface (not shown) and a bottom surface (not shown). The base plate assembly 102 may further include a peripheral wall 108 extending between the top surface and the bottom surface. The bottom surface of the base plate assembly 102 will be explained in detail in conjunction with FIG. 2.

Moreover, the top surface of the base plate assembly 102 may be configured with the holding member 104. More specifically, the holding member 104 may be mounted on the top surface of the base plate assembly 102. The holding member 104 is configured to have a shape, which enables a user to hold the carpet seaming apparatus 100 therewith. In an embodiment of the present invention, the holding member 104 includes a body portion 104a and a stem portion 104b extending from the body portion 104a. The body portion 104a is mounted on the top surface of the base plate assembly 102. As shown in FIG. 1, the stem portion 104b is adapted to receive the user's fingers thereon for enabling the user to carry the carpet seaming apparatus 100 from one place to another place. However, it will be evident to a person skilled in the art that holding member 104 may be configured to have any other shape that enables the user to hold the carpet seaming apparatus 100 therewith. Additionally, the holding member 104 may be composed of a heat resistant material such as an injection-molded plastic, an epoxy material, an injection-molded rubber, a ceramic material, and the like. However, it will be apparent to a person skilled in the art that any other material that provides sufficient structural integrity may also be utilized for forming the holding member 104. Further, the material of the holding member 104 may take the appearance of a black color, or any other color.

In an embodiment of the present invention, the top surface of the base plate assembly 102 may be configured with an air cooled heat shield (not shown). More specifically, the air cooled heat shield may be mounted over base plate assembly 102 and the holding member 104 may be configured on the air cooled heat shield. The air cooled heat shield may shield an operator of the carpet seaming apparatus 100 and synthetic fibers of the carpet from the temperatures generated at the base plate assembly 102.

Moreover, the holding member 104 is configured with the power unit 106. In an embodiment of the present invention, the power unit 106 may be configured within the stem portion 104b of the holding member 104, as depicted in FIG. 1. It will be evident to a person skilled in the art that the power unit 106 may be disposed at other portions, such as the body portion 104b, of the holding member 104. Further, the power unit 106 is operatively coupled to the base plate assembly 102 and is adapted to supply the electrical power to the base plate assembly 102 for enabling the base plate assembly 102 to be heated. Though the operative coupling between the power unit 106 and the base plate assembly 102 has not been illustrated in FIG. 1, it will be evident to a person skilled in the art that the operative coupling may be enabled with the help of electrical wires. Moreover, in an embodiment of the present invention, the power unit 106 may include a battery pack having a plurality of batteries that are secured within the battery pack and that supplies the electrical power to the carpet seaming apparatus 100. More specifically, the plurality of batteries may be secured within the battery pack and are arranged in a packaged form. For instance, as illustrated in FIG. 1, the battery pack includes two batteries connected in an end to end fashion, with the batteries having voltage ratings of an appropriate voltage between 28 to 300 volts, and with the preferred power rating being 1600 watts. However, it will be apparent to a person skilled in the art that the battery pack may include any number of batteries connected in any other fashion known in the art. Accordingly, the power unit 106 avoids a need for connecting the carpet seaming apparatus 100 to an external power source, thereby enabling the carpets seaming apparatus 100 to be easily portable.

Without limiting the scope of the invention, the batteries utilized in the battery pack may include rechargeable batteries. The rechargeable batteries may be separately charged and secured within the battery pack while using the carpet seaming apparatus 100. After use, the rechargeable batteries may be recharged by an external charging device. Once the rechargeable batteries are charged, the batteries may be reused by securing the batteries in the battery pack.

Further, in an alternate embodiment of the present invention, the battery pack may be configured to enable the recharging of the rechargeable batteries. In such an embodiment, the battery pack may be adapted to receive the electrical power from an external power source for enabling the battery pack to recharge the batteries disposed therewithin.

Moreover, the operative coupling between the base plate assembly 102 and the power unit 106 may be controlled by a switch 110 configured on the holding member 104. More specifically, the switch 110 may be operated by a user to operate the power unit 106 to start or stop the supply of the electrical power to the base plate assembly 102 therefrom.

The carpet seaming apparatus 100 may further include a temperature controlling means 112 configured at the holding member 104. The temperature controlling means 112 is adapted to control heating of the base plate assembly 102. More specifically, the temperature controlling means 112 may be operatively coupled to the base plate assembly 102 and the power unit 106. The temperature controlling means 112 may be utilized to control a temperature of the base plate assembly 102 with the help of a temperature selecting switch 114 (hereinafter referred to as “the selecting switch 114”). While using the carpet seaming apparatus 100, the selecting switch 114 may be utilized by a user to set a desired temperature of the base plate assembly 102. Once the base plate assembly 102 achieves the desired temperature, the temperature controlling means 112 disconnects the electrical power between the power unit 106 and the base plate assembly 102, thereby avoiding a further heating of the base plate assembly 102 and controlling the temperature thereof. When the temperature of the base plate assembly 102 falls below the desired temperature, the temperature controlling means 112 enables the supply of electrical power between the base plate assembly 102 and the power unit 106 for heating the base plate assembly 102.

In an embodiment of the present invention, the disconnection and enablement of the supply of electrical power between the base plate assembly 102 and the power unit 106 may be indicated by a light indicator (not shown) configured in the carpet seaming apparatus 100. More specifically, the temperature controlling means 112 may be operatively coupled to the light indicator. During operation, when the supply of the electrical power between the base plate assembly 102 and the power unit 106 is enabled, the light indicator may glow indicating the enablement of supply of the electrical power. Further, when supply of the electrical power between the base plate assembly 102 and the power unit 106 is disconnected, the light indicator may turn off indicating the interruption of the supply of the electrical power.

The temperature controlling means 112 may include a thermostat, or any other temperature controlling device known in the art. In an embodiment of the present invention, the temperature controlling means 112 and the selecting switch 114 may be configured within the body portion 104a of the holding member 104, as shown in FIG. 1. It will be evident to a person skilled in the art that the temperature controlling means 112 and the selecting switch 114 may be configured in any other portions of the holding member 104.

The carpet seaming apparatus 100 may further include a heating element (not shown) coupled to the base plate assembly 102. The heating element is capable of heating the base plate assembly 102. More specifically, the heating element may be coupled to the temperature controlling means 112 and the base plate assembly 102. The temperature controlling means 112 controls the temperature of the heating element. In an embodiment of the present invention, the heating element may assume an ‘S’ shaped structure for facilitating uniform distribution of heat throughout the base plate assembly 102. It will be evident to a person skilled in the art that the heating element used in the carpet seaming apparatus 100 may assume any other shapes known in the art.

In use, the carpet seaming apparatus 100 may be utilized to couple a pair of carpets together. Initially, the carpet seaming apparatus 100 is operated by the switch 110 which operates the power unit 106 to supply electrical power to the base plate assembly 102. As a result, the base plate assembly 102 is heated up. Subsequently, the heated base plate assembly 102 may be moved along a length of a glued surface of the seaming tape, which melts the glue present on the glued surface of the seaming tape. Subsequently, the user places edges of the pair of carpets on the glued surface, such that the edges adjoin to each other to form a joint therebetween. The melted glue of the glued surface allows the seaming tape to adhere to the edges of the carpets to form the joint. As a result, the pair of carpets is coupled to each other.

Referring now to FIG. 2, a bottom view of the carpet seaming apparatus 100 of FIG. 1 is illustrated. More specifically, the bottom surface, such as a bottom surface 200, of the carpet seaming apparatus 100 is shown in FIG. 2. The bottom surface 200 may include a plurality of grooves 202 (hereinafter referred to as “the grooves 202”) that enable the carpet seaming apparatus 100 to be utilized with a variety of seaming tapes. For instance, the seaming tape may have a plurality of parallel beads of glue configured on a glued surface of the seaming tape. The plurality of parallel beads of glue may extend substantially along a length of the seaming tape. The grooves 202 are adapted to accommodate the plurality of parallel beads of glue therewithin. More specifically, while moving the carpet seaming apparatus 100 on the seaming tape, the grooves 202 match with the plurality of parallel beads of glue on the glued surface of the seaming tape, thereby enabling the carpet seaming apparatus 100 to maintain a proper alignment with the seaming tape. The proper alignment indicates that the carpet seaming apparatus 100 may be centered with the seaming tape while moving along the seaming tape.

Moreover, in an embodiment of the present invention, the bottom surface 200 may be coated with a non-stick material. The presence of the non-stick material precludes the glue present on the glued surface of the seaming tape from sticking on to the bottom surface 200 of the base plate assembly 102 during operation. It will be apparent to a person skilled in the art that the non-stick material used may be a material known in the art.

The carpet seaming apparatus, as described herein, may be provided with a carrying case. The carrying case enables the user to conveniently carry the carpet seaming apparatus. In an embodiment of the present invention, the carpet seaming apparatus may be provided along with a charging device for charging the power unit 106. In an exemplary embodiment of the present invention, the carpet seaming apparatus such as the carpet seaming apparatus 100 may have a length of about 10 inches, a width of about 3½ inches and a height of about 5½ inches. In another exemplary embodiment of the present invention, the carpet seaming apparatus such as carpet seaming apparatus 100 may have a length of about 12 inches, a width of about 4 inches and a height of about 6 inches.

The carpet seaming apparatus, explained in conjunction with FIGS. 1 and 2, may be advantageously used by a user for coupling a pair of carpets with each other. Moreover, the carpet seaming apparatus is battery operated and thus may not require an external power source thereby providing a convenient portability thereof. Moreover, the absence of wires in the carpet seaming apparatus avoids a need for frequent adjustment of the wires and entangling of wires during the operation of the carpet seaming apparatus. Further, presence of grooves on the bottom surface of the carpet seaming apparatus enables the carpet seaming apparatus to be utilized with a variety of seaming tapes. Furthermore, the non-stick coating of the bottom surface of the base plate assembly prevents the glue of the glued surface of the seaming tape from sticking on to the bottom surface during operation of the carpet seaming apparatus. Accordingly, frequent cleaning of the bottom surface of the base plate assembly may be avoided. Further, the carpet seaming apparatus has a low profile structure that enables the carpet seaming apparatus to uniformly distribute heat for effectively coupling the pair of carpets.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A carpet seaming apparatus comprising:
a base plate assembly having a top surface and a bottom surface, the base plate assembly adapted to be heated upon receiving electric power;
a holding member mounted on the top surface of the base plate assembly, the holding member configured to enable a user to hold the carpet seaming apparatus therewith; and
a power unit configured at the holding member and operatively coupled to the base plate assembly, the power unit capable of supplying the electric power for heating the base plate assembly.

2. The carpet seaming apparatus of claim 1, wherein the bottom surface of the base plate assembly is configured with a plurality of grooves extending substantially along a length of the base plate assembly.

3. The carpet seaming apparatus of claim 1, wherein the bottom surface of the base plate assembly is coated with a non-stick coating material.

4. The carpet seaming apparatus of claim 1, wherein the holding member is composed of a heat resistant material.

5. The carpet seaming apparatus of claim 1, wherein the power unit comprises a battery pack.

6. The carpet seaming apparatus of claim 5, wherein the battery pack is a rechargeable battery pack.

7. The carpet seaming apparatus of claim 1, further comprising a temperature controlling means operatively coupled to the base plate assembly and the power unit, the temperature controlling means capable of controlling a temperature of the base plate assembly.
